(19) United States
(12) Patent Application Publication
(10) Pub. No.: US 2014/0049498 A1
(43) Pub. Date: Feb. 20, 2014

(54) METHOD AND MOBILE TERMINAL DEVICE FOR IMAGE OPERATION

(71) Applicant: TENCENT TECHNOLOGY (SHENZHEN) COMPANY LIMITED, Shenzhen (CN)

(72) Inventors: NING MA, Shenzhen (CN); SIRUI LIU, Shenzhen (CN); YONG YAO, Shenzhen (CN); SHA MO, Shenzhen (CN)

(73) Assignee: TENCENT TECHNOLOGY (SHENZHEN) COMPANY LIMITED, Shenzhen (CN)

(21) Appl. No.: 14/063,270

(22) Filed: Oct. 25, 2013

Related U.S. Application Data
(63) Continuation of application No. PCT/CN2013/080253, filed on Jul. 27, 2013.

(30) Foreign Application Priority Data
Jul. 30, 2012 (CN) 201210267020.6

(51) Int. Cl. G06F 3/041

(52) U.S. Cl. CPC G06F 3/0412
USPC 345/173

(57) ABSTRACT

Methods and mobile terminal devices for image operation are disclosed. In an exemplary method, an image viewing request from a user can be obtained. The image viewing request can include image identification. The mobile terminal can switch to an image mode from a current interface to display an image corresponding to the image identification on a main interface of the image mode. The mobile terminal can obtain a first operation request from the user and enter a first operation interface under the image mode to perform a first operation on the image and to generate a first operation image. The mobile terminal can obtain a second operation request from the user and enter a second operation interface to perform a second operation on the first operation image.

### CROSS-REFERENCES TO RELATED APPLICATIONS

This application is a continuation of PCT Patent Application No. PCT/CN2013/080253, filed on Jul. 27, 2013, which claims priority to Chinese Patent Application No. CN201210267020.6, filed on Jul. 30, 2012, the entire contents of all of which are incorporated herein by reference.

### FIELD OF THE DISCLOSURE

The present disclosure relates to the field of mobile communications and, more particularly, relates methods and mobile terminal devices for image operation.

### BACKGROUND

As touch screens with multi-touch control can be supported by mainstream operating systems including IOS, Android, and WP7, touch screen mobile terminals have been continuously developed and have now become an indispensable tool in daily life. Browser is a software/program that each touch screen mobile terminal must install and use. A large fraction of daily webpage browsing is the browsing of images. In-depth operations on images such as saving, editing, and/or sharing are essential operations in basic browsing experience.

Conventional image operation methods on a touch screen mobile terminal include image browsing methods provided by a webpage, and a method of long pressing on an image on a webpage. For example, when operating on an image using image browsing methods provided by a webpage, e.g., in image channels of various websites, images can be viewed in detail using methods such as page turning, scrolling, linking, etc., within webpages through HTML (Hypertext Markup Language). Alternatively, for in-depth image operations, a user may long press on the area of an image. A dialog box can thus pop up. The user can then select corresponding operations on the image from the dialog box including browsing, saving, sharing, etc.

Conventional image operation methods may have at least the following issues. When operating on images using image browsing methods provided by a webpage, the browsing may entirely depend on functions provided by the webpage. Due to the limited capabilities provided by conventional webpages, existing functions for operating images on webpages are essentially limited to the browsing functions, which are limited functions with poor operability and cannot provide users with sufficient options to meet various needs for collecting and/or sharing from the users.

When browsing an image (i.e., operating on an image) through long pressing on the image on a webpage, the features of touch screen devices are not fully utilized, and operating procedures can be complicated. In addition, multiple operations cannot be performed in that case. That is, only one image operation action can be completed each time. If another image operation action needs to be completed, the area of the image needs to be long pressed again. Further, vivid visual effects cannot be produced. Such operations are complicated and rigid with nothing new for the users to experience.

### BRIEF SUMMARY OF THE DISCLOSURE

According to various embodiments, there is provided an image operation method. In this method, a mobile terminal can obtain an image viewing request from a user. The image viewing request can include image identification. The mobile terminal can switch to an image mode from a current interface to display an image corresponding to the image identification on a main interface of the image mode. The mobile terminal can obtain a first operation request from the user and enter a first operation interface under the image mode, to perform a first operation on the image and to generate a first operation image. The mobile terminal can obtain a second operation request from the user and enter a second operation interface to perform a second operation on the first operation image.

According to various embodiments, there is provided a mobile terminal device that supports a touch operation. The mobile terminal device can include an obtaining module, a switching module, a first operating module, and/or a second operating module. The obtaining module can be configured to obtain an image viewing request from a user, wherein the image viewing request comprises image identification. The switching module can be configured to switch to an image mode from a current interface to display an image corresponding to the image identification on a main interface of the image mode. The first operating module can be configured to obtain a first operation request from the user, to enter a first operation interface under the image mode, and to perform a first operation on the image to generate a first operation image. The second operating module can be configured to obtain a second operation request from the user, to enter a second operation interface, and to perform a second operation on the first operation image.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts a flow diagram of an exemplary image operation method in accordance with various disclosed embodiments;

FIG. 2 depicts a flow diagram of another exemplary image operation method in accordance with various disclosed embodiments;

FIG. 3 depicts a structure diagram of an exemplary mobile terminal in accordance with various disclosed embodiments;

FIG. 4 depicts a structure diagram of another exemplary mobile terminal in accordance with various disclosed embodiments;

FIG. 5 depicts a structure diagram of another exemplary mobile terminal in accordance with various disclosed embodiments;

FIG. 6 depicts an exemplary environment incorporating certain disclosed embodiments; and

FIG. 7 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

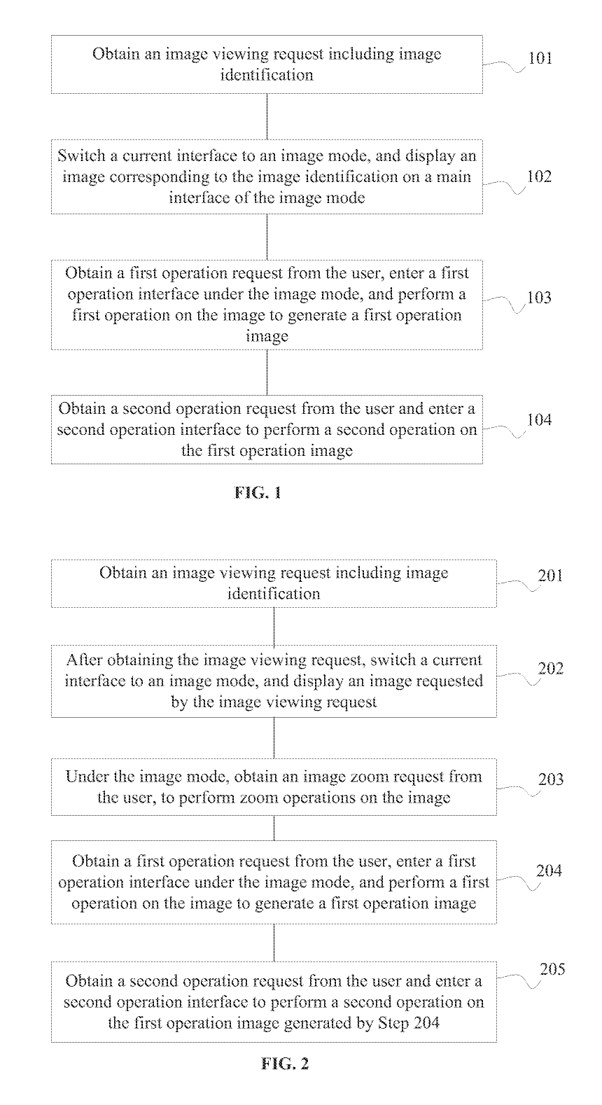

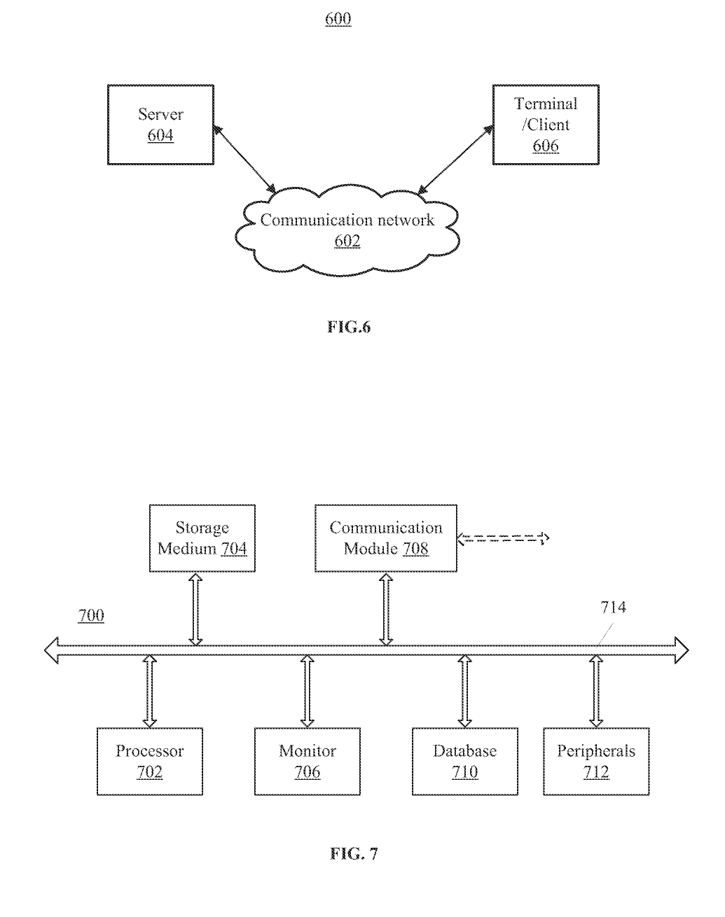

FIGS. 1-5 depict exemplary methods and mobile terminal devices for image operation in accordance with various disclosed embodiments. The exemplary methods and devices can be implemented, for example, in an exemplary environment 600 as shown in FIG. 6.

As shown in FIG. 6, the environment 600 can include a server 604, a terminal 606, and a communication network 602. The server 604 and the terminal 606 may be coupled through the communication network 602 for information exchange, for example, Internet searching, webpage browsing, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal device with certain computing capabilities, for example, a personal computer (PC), a work station computer, a server computer, a hand-held computing device (tablet), a mobile terminal (a mobile phone or a smart phone), or any other user-side computing device. In various embodiments, the terms “terminal” and “terminal device” can be used interchangeably.

A server, as used herein, may refer one or more server computers configured to provide certain server functionalities, for example, search engines and database management. A server may also include one or more processors to execute computer programs in parallel.

The server 604 and the terminal 606 may be implemented on any appropriate computing platform. FIG. 7 shows a block diagram of an exemplary computing system 700 capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, for example, ROM, RAM, and flash memory modules, and mass storages, for example, CD-ROM, U-disk, removable hard disk, etc. The storage medium 704 may store computer programs for implementing various processes, when executed by the processor 702.

Further, the peripherals 712 may include I/O devices, for example, keyboard and mouse, and the communication module 708 may include network devices for establishing connections through the communication network 602. The database 710 may include one or more databases for storing certain data and for performing certain operations on the stored data, for example, webpage browsing, database searching, etc.

In operation, the terminal 606 may cause the server 604 to perform certain actions, for example, an Internet search or other database operations. The server 604 may be configured to provide structures and functions for such actions and operations. More particularly, the server 604 may include a data searching system for real-time database searching. In various embodiments, a terminal, for example, a mobile terminal involved in the disclosed methods and systems can include the terminal 606.

FIG. 1 depicts a flow diagram of an exemplary image operation method in accordance with various disclosed embodiments. In one embodiment, the exemplary method can be executed by, e.g., a touch screen mobile terminal that can support multi-touch control of a touch screen. For example, the touch screen mobile terminal can be a smart phone, a tablet computer, a personal digital assistant (PDA), etc.

A touch screen can be a liquid crystal display device capable of receiving inputted signals. When a pattern or an image on the screen is touched by a user, a touch feedback system on the screen can send feedback to the user according to a pre-programmed software/program.

A typical touch screen gesture operation includes the following. When a finger or other suitable object touches the screen, the touch screen system locates and verifies information inputted according to a pattern/icon or position touched by the finger or other suitable object. The touching can be one or more of touch gestures including, but not limited to, sliding, dragging, long pressing, clicking (tapping), etc.

The touch screen may often include a touch detection apparatus and a touch screen controller. The touch detection apparatus can be installed in front of the screen, and can be used to detect and receive the position information of the touching by the user and send the position information to the touch screen controller. The touch screen controller can receive the information sent from the touch detection apparatus, transform the information into coordinates of point(s), and send the coordinates of point(s) to, for example, a central processing unit (CPU). The touch screen controller can also receive commands from the CPU to display on the screen.

Referring back to FIG. 1, in Step 101 of FIG. 1, an image viewing request (i.e., a request for viewing an image) from a user is obtained. The image viewing request can include image identification.

In Step 102, a current interface is switched to an image mode. An image corresponding to the image identification can be displayed on a main interface of the image mode.

In Step 103, a first operation request from the user is obtained. The mobile terminal can enter a first operation interface under the image mode, to perform a first operation on the image and generate a first operation image.

In Step 104, a second operation request from the user is obtained. The mobile terminal can enter a second operation interface to perform a second operation on the first operation image.

In various embodiments, before obtaining the first operation request from the user, the method can include the following steps, for example, detecting whether an image-mode exiting request (i.e., a request for exiting an image mode) is received, and exiting the image mode to end the operation, when the image mode exiting request is received.

Accordingly, before obtaining the second operation request from the user, the method can include the following steps, for example, detecting whether a first operation interface exiting request is received, and returning to the image mode, when the first operation interface exiting request is received.

After entering the second operation interface and performing the second operation on the first operation image, the following steps can be included: generating a second operation image, and continuing to perform operations on the second operation image corresponding to other operation requests when other operation requests from the user are obtained.

Alternatively, after entering the second operation interface and performing the second operation on the first operation image, the following steps can be included: generating a second operation image; saving the second operation image; exiting the second operation interface and switching to the image mode; and exiting the image mode.

When switching to the image mode from the current interface and displaying the image corresponding to the image identification on the main interface of the image mode (e.g., as depicted in Step 102), the exemplary method can further include, for example, after displaying the image corresponding to the image identification on the main interface of the image mode, displaying a plurality of operation identifiers around the image. The operation identifiers can include a first operation identifier corresponding to the first operation request and a second operation identifier corresponding to the second operation request.

Furthermore, obtaining the first operation request from the user can include: obtaining the first operation request containing the first operation identifier, after the user triggers the first operation identifier to form the first operation request. Accordingly, the obtaining of the second operation request from the user can include: obtaining the second operation request containing the second operation identifier, after the user triggers the second operation identifier to form the second operation request.

By using the exemplary image operation methods in accordance with various disclosed embodiments, a variety of image operation modes can be achieved in a browser on a touch screen mobile terminal that can support multi-touch control. Users can operate on and browse images on webpages more conveniently and specifically. The users can thus be freed from the dependence on the functions of webpages. Complicated and repetitive operation steps can be reduced. In addition, vivid visual effects of images can be produced. As a result, operations can be smoother and can better match the features of touch screens and the users' using habits. The use experience can be greatly improved.

FIG. 2 depicts a flow diagram of another exemplary image operation method in accordance with various disclosed embodiments. In one embodiment, the exemplary method can be executed by, e.g., a touch screen mobile terminal that can support multi-touch control of a touch screen. Specifically, the touch screen mobile terminal can be a smart phone, tablet computer, personal digital assistant (PDA), etc. Operations on images can include, but are not limited to, image browsing, saving, editing, sharing, etc.

In Step 201, an image viewing request from a user is obtained, wherein the image viewing request can include image identification. For example, a user can first open a browser of the touch screen mobile terminal and browse images on a webpage in a normal or usual manner. When seeing an image of interest, the user can send an image viewing request. The image viewing request can include the image identification of the image.

That the user sends the image viewing request can include, for example, long pressing on the image for about 2 seconds or any other defined time length. Other suitable methods for sending the image viewing request and/or other suitable time length of the long press can be set and included without limitation in accordance with various embodiments of the present disclosure.

In Step 202, after the touch screen mobile terminal obtains the image viewing request, a current interface is switched to an image mode. The image requested by the image viewing request can be displayed on a main interface of the image mode. For example, after obtaining the image viewing request, the touch screen mobile terminal can first switch the current interface to the image mode and then display the image requested (or identified) by the image viewing request on the main interface of the image mode.

After entering the image mode, the original webpage shown by the browser can recede to the backstage or can be covered by a translucent mask. The image that the user desires to view can thus be displayed on the main interface (e.g., the main interface of the image mode) of the touch screen mobile terminal.

In one embodiment, after the image requested by the user is displayed on the main interface of the image mode, a plurality of operation identifiers can be displayed around the image. The operation identifiers can be used for operations including, but not limited to, editing, saving, collecting, sharing, etc., from which the user can choose as needed with flexibility. The operation identifiers can be arranged on (e.g., around) the image in a variety of ways. For example, the operation identifiers can be arranged around the image in a square shape, a circular shape or any suitable shape without limitation. The sequential order of arranging the operation identifiers can be set by the user in a flexible manner. For example, the operation(s) that the user may frequently use can be arranged with a higher priority, according to the times (i.e., frequency) of the user's operations. The user can also change the arrangement at any time as desired.

In Step 203, under the image mode, an image zoom request from the user is obtained, and zoom operations can be performed on the image.

Under the image mode, the user may want to zoom out or zoom in the image in order to view the image more clearly. Thus, the user can send an image zoom request. Generally, image zoom identifiers can be displayed at one corner of the image, e.g., having a “+” sign and a “−” sign. The “+” sign can represent zooming in and the “−” sign can represent zooming out. The user can send the image zoom request through the image zoom identifiers on or around the image. For example, clicking the “+” sign can represent sending a zoom-in request and clicking the “−” sign can represent sending a zoom-out request. So zoom-in or zoom-out operations can be performed correspondingly on the image according to the users' clicking. In addition, the user can also perform zoom-in or zoom-out operations on the image through finger sliding. For example, two fingers sliding outward can represent zooming in, and two fingers sliding inward can represent zooming out. Various suitable methods for zooming in/out an image can be included in the present disclosure without limitation.

In Step 204, a first operation request from the user is obtained. A first operation interface can be entered on the mobile terminal under the image mode to perform a first operation on the image and generate a first operation image.

For example, under the image mode, the user may need to choose the first operation and send the first operation request. The first operation can be the operation(s) including, but not limited to, editing, saving, collecting, sharing, etc. After entering the first operation interface and performing the first operation on the image, the first operation image can be generated. For example, the first operation chosen by the user can be an editing operation. The user can long press on the image for about two seconds or other suitable time length, then drag the image directly onto an editing identifier that is displayed around the image, and then enter an editing operation interface to perform the editing operation. The image after editing can thus be the first image (i.e., the first operation image). In addition, long pressing on the image for about two seconds can be one of the methods for the user to trigger the first operation to perform the first operation request, and other suitable methods can be chosen without limitation in the present disclosure.

In one embodiment, before the user sends the first operation request, the mobile terminal may need to detect whether an image mode exiting request is received. If the image mode exiting request is received, the system may need to exit the image mode to end the operation. If the image mode exiting request is not received, the exemplary method can proceed to perform Step 205.

If the first operation request from the user further includes a zoom request, the mobile terminal can enter the first operation interface and perform zoom operations (e.g., zoom-in and/or zoom-out operations) on the image. Specific zoom operations can be similar to or the same as corresponding operations depicted in the various disclosed embodiments, e.g. as depicted in Step 203.

In Step 205, a second operation request from the user is obtained. The mobile terminal can enter a second operation interface and perform a second operation on the first operation image generated in Step 204.

For example, under the image mode, after completing the first operation, the user may need to continue to choose the second operation as needed and send the second operation request. The second operation can be any of the operations including, but not limited to, editing, saving, collecting, sharing, etc. After entering the second operation interface and performing the second operation on the image, the second operation image can be generated. For example, the second operation chosen by the user can be a sharing operation. The user can long press on the image for about two seconds, then drag the image directly onto a sharing identifier that is displayed around the image, and then enter a sharing operation interface to perform a corresponding operation. The image after sharing can thus be the second image (i.e., the second operation image). In addition to long pressing on the image for about two seconds, other suitable methods can be used for the user to trigger the second operation to perform the second operation request without limitation in the present disclosure.

In an embodiment where the second operation request from the user further includes a second zoom request, the mobile terminal can enter the second operation interface under the image mode and perform zoom operations (e.g., zoom-in and/or zoom-out operations) on the first operation image. Specific zoom operations can be similar to or the same as corresponding operations depicted in various disclosed embodiments, e.g. as depicted in Step 203.

After the second operation is performed on the first operation image, the second operation image can be generated. The second operation image can then be saved. The mobile terminal can exit the second operation interface and switch to the image mode, and then exit the image mode. If other operation requests from the user are obtained after the second operation image is generated, operations corresponding to other operation requests can continue to be performed on the second operation image, until all the operations from the user are ended and the mobile terminal exits the image mode.

By using the image operation methods in accordance with various disclosed embodiments, a variety of image operation modes and flexible image zoom operations can be achieved in a browser on a touch screen mobile terminal that supports multi-touch control. Users can operate on and browse images on webpages more conveniently and specifically. The users can thus be freed from the dependence on the functions of webpages. Complicated and repetitive operation steps can be reduced. In addition, vivid visual effects of images can be produced. As a result, operations can be smoother and can better match the features of touch screens and the users' using habits. Use experience can be greatly improved.

FIG. 3 depicts a structure diagram of an exemplary mobile terminal in accordance with various disclosed embodiments. The exemplary mobile terminal can be a touch screen mobile terminal that supports multi-touch control. The exemplary mobile terminal can include, for example, a smart phone, tablet computer, personal digital assistant (PDA), etc. Referring to FIG. 3, the mobile terminal can include an obtaining module 301, a switching module 302, a first operating module 303, and/or a second operating module 304.

The obtaining module 301 is configured to obtain an image viewing request from a user. The image viewing request can include image identification.

The switching module 302 is configured to switch a current interface to an image mode. An image corresponding to the image identification can be displayed on a main interface of the image mode.

The first operating module 303 is configured to obtain a first operation request from the user, enter a first operation interface under the image mode, and perform a first operation on the image to generate a first operation image.

The second operating module 304 is configured to obtain a second operation request from the user, enter a second operation interface, and perform a second operation on the first operation image.

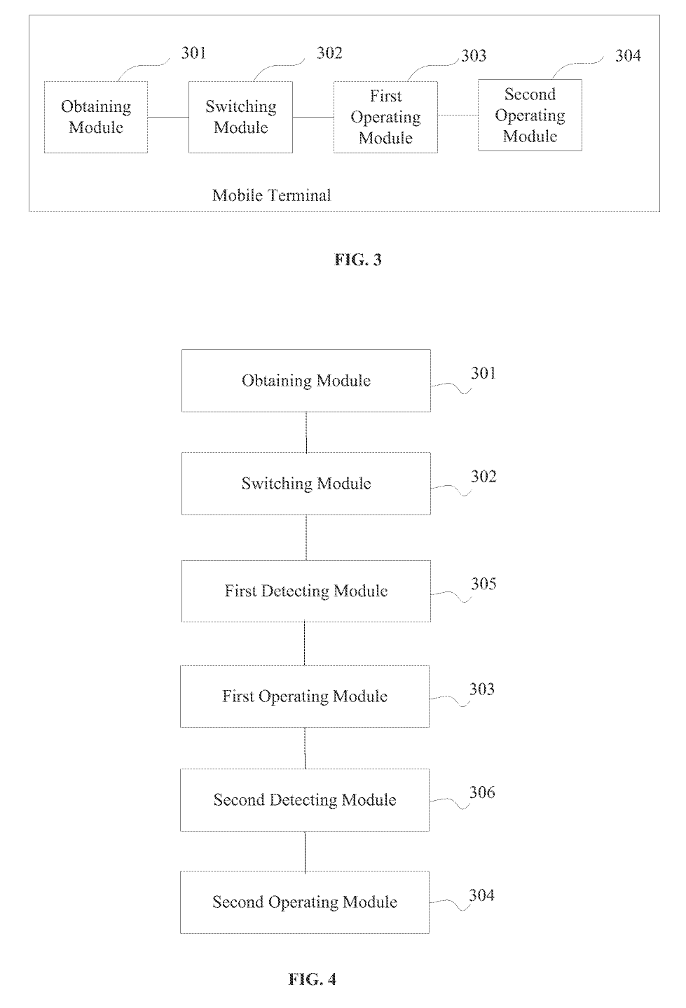

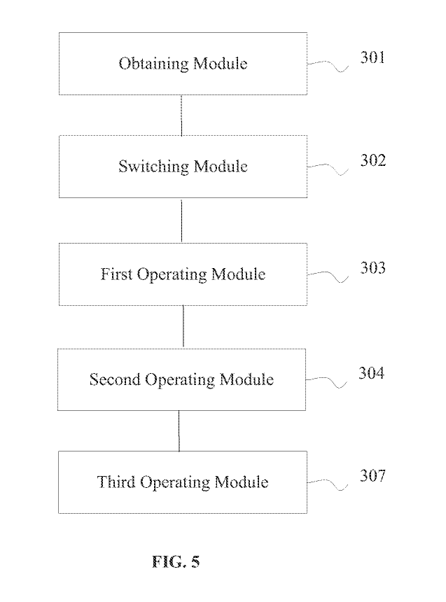

FIG. 4 depicts a structure diagram of another exemplary mobile terminal in accordance with various disclosed embodiments. The exemplary mobile terminal in FIG. 4 can further include a first detecting module 305 and/or a second detecting module 306 as compared with the exemplary mobile terminal depicted in FIG. 3.

The first detecting module 305 is configured to detect whether an image mode exiting request is received before the obtaining of the first operation request from the user. The first detecting module 305 is also configured to exit the image mode and end operation when the image mode exiting request is received.

The second detecting module 306 is configured to detect whether a first operation interface exiting request is received before the obtaining of the second operation request from the user. The second detecting module 306 is also configured to return to the image mode when the first operation interface exiting request is received.

FIG. 5 depicts a structure diagram of another exemplary mobile terminal in accordance with various disclosed embodiments. Referring to FIG. 5, the exemplary mobile terminal can further include a third operating module 307 as compared with the exemplary mobile terminal depicted in FIG. 3.

The third operating module 307 is configured to generate a second operation image, and to continue to perform operations on the second operation image corresponding to other operation requests from the user, when other operation requests from the user are received. The third operating module 307 is also configured to save the second operation image after generating the second operation image, to exit the second operation interface to switch to the image mode, and then to exit the image mode.

The switching module 302 is also configured to display a plurality of operation identifiers around the image after the image is displayed on the main interface of the image mode. The operation identifiers can include a first operation identifier corresponding to the first operation request and a second operation identifier corresponding to the second operation request.

The first operating module 303 is further configured to obtain the first operation request containing the first operation identifier, after the user triggers the first operation identifier to form the first operation request.

The second operating module 304 is further configured to obtain the second operation request containing the second operation identifier, after the user triggers the second operation identifier to form the second operation request.

By using the mobile terminal in accordance with various disclosed embodiments, a variety of image operation modes and flexible image zoom operations can be achieved using a browser on a touch screen mobile terminal that supports multi-touch control. Users can operate on and browse images on webpages more conveniently and specifically. The users can thus be freed from the dependence on the functions of webpages. Complicated and repetitive operation steps can be reduced. In addition, vivid visual effects of images can be produced. As a result, operations can be smoother and can better match the features of touch screens and the users' using habits. Use experience can be greatly improved.

When image operations are performed by the mobile terminal according to various disclosed embodiments, the functional modules are defined and specified as depicted above only for illustrative purposes. In practical applications, the above-described functions can be allocated to different functional modules to be accomplished. That is, the internal structure of the mobile terminal can be divided into different functional modules, in order to complete one or more or all of the above-described functions. In addition, the mobile terminals according to various disclosed embodiments and the image operation methods as depicted in various disclosed embodiments belong to the same inventive concept.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

In various embodiments, one or more or all of the steps in each of the exemplary methods herein can be accomplished using hardware and/or using a program/software to instruct related hardware. Such program/software can be stored

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and mobile terminal devices for image operation are disclosed herein in the field of mobile communication. In an exemplary method, an image viewing request from a user can be obtained, wherein the image viewing request can include image identification. A current interface can be switched to an image mode and an image corresponding to the image identification can be displayed on a main interface of the image mode. A first operation request from the user can be obtained. Under the image mode, the mobile terminal can enter a first operation interface, to perform a first operation on the image and generate a first operation image. A second operation request from the user can be obtained. The mobile terminal can enter a second operation interface, to perform a second operation on the first operation image. An exemplary mobile terminal device can include an obtaining module, a switching module, a first operating module, and/or a second operating module.

By using the methods and mobile terminal devices for image operations in accordance with various disclosed embodiments, a variety of image operation modes and flexible image zoom operations can be achieved using a browser on a touch screen mobile terminal that supports multi-touch control. Users can operate on and browse images on webpages more conveniently and specifically. The users can thus be freed from the dependence on the functions of webpages. Complicated and repetitive operation steps can be reduced. In addition, vivid visual effects of images can be produced. As a result, operations can be smoother and can better match the features of touch screens and the users' using habits. Use experience can be greatly improved

What is claimed is:

1. An image operation method comprising:
obtaining, by a mobile terminal, an image viewing request from a user, wherein the image viewing request comprises image identification;
switching, by the mobile terminal, to an image mode from a current interface to display an image corresponding to the image identification on a main interface of the image mode;
obtaining, by the mobile terminal, a first operation request from the user and entering a first operation interface under the image mode, to perform a first operation on the image and to generate a first operation image; and
obtaining, by the mobile terminal, a second operation request from the user and entering a second operation interface to perform a second operation on the first operation image.

2. The method of claim 1, wherein, before the obtaining of the first operation request from the user, the method further comprises:
detecting, by the mobile terminal, whether an image mode exiting request is received, and
exiting the image mode and ending operation when the image mode exiting request is received.

3. The method of claim 1, wherein, before the obtaining of the second operation request from the user, the method further comprises:
detecting, by the mobile terminal, whether a first operation interface exiting request is received, and
returning to the image mode when the first operation interface exiting request is received.

4. The method of claim 1, wherein, after the entering of the second operation interface and the performing of the second operation on the first operation image, the method further comprises:
generating, by the mobile terminal, a second operation image, and
when additional operation requests from the user are obtained, continuing to perform operations on the second operation image corresponding to the additional operation requests.

5. The method of claim 1, wherein, after the entering of the second operation interface and the performing of the second operation on the first operation image, the method further comprises:
generating, by the mobile terminal, a second operation image,
saving the second operation image,
exiting the second operation interface to switch to the image mode, and
exiting the image mode.

6. The method of claim 1, wherein, after the displaying of the image corresponding to the image identification on the main interface of the image mode, the method further comprises:
displaying, by the mobile terminal, a plurality of operation identifiers around the image, wherein the operation identifiers comprise a first operation identifier corresponding to the first operation request and a second operation identifier corresponding to the second operation request.

7. The method of claim 6, wherein the obtaining of the first operation request from the user comprises:
obtaining, by the mobile terminal, the first operation request containing the first operation identifier, after the user triggers the first operation identifier to form the first operation request.

8. The method of claim 6, wherein the obtaining of the second operation request from the user comprises:
obtaining, by the mobile terminal, the second operation request containing the second operation identifier, after the user triggers the second operation identifier to form the second operation request.

9. A mobile terminal device that supports a touch operation, the mobile terminal device comprising:
an obtaining module, configured to obtain an image viewing request from a user, wherein the image viewing request comprises image identification;
a switching module, configured to switch to an image mode from a current interface to display an image corresponding to the image identification on a main interface of the image mode;
a first operating module, configured to obtain a first operation request from the user, to enter a first operation interface under the image mode, and to perform a first operation on the image to generate a first operation image; and
a second operating module, configured to obtain a second operation request from the user, to enter a second operation interface, and to perform a second operation on the first operation image.

10. The device of claim 9, further comprising:
a first detecting module, configured to detect whether an image mode exiting request is received before the first operation request is obtained from the user, and to exit the image mode and end the first operation when the image mode exiting request is received; and
a second detecting module, configured to detect whether a first operation interface exiting request is received before the second operation request is obtained from the user, and to return to the image mode when the first operation interface exiting request is received.

11. The device of claim 9, further comprising a third operating module, configured to:
generate a second operation image, and continue to perform operations on the second operation image corresponding to additional operation requests from the user when the additional operation requests from the user are received.

12. The device of claim 11, wherein the third operating module is configured to save the second operation image after the second operation image is generated, to exit the second operation interface to switch to the image mode, and to exit the image mode.

13. The device of claim 9, wherein the switching module is further configured to display a plurality of operation identifiers around the image after the image is displayed on the main interface of the image mode, and wherein the plurality of operation identifiers comprise a first operation identifier corresponding to the first operation request and a second operation identifier corresponding to the second operation request.

14. The device of claim 13, wherein the first operating module is further configured to obtain the first operation request containing the first operation identifier, after the user triggers the first operation identifier to form the first operation request.

15. The device of claim 13, wherein the second operating module is further configured to obtain the second operation request containing the second operation identifier, after the user triggers the second operation identifier to form the second operation request.
